(19) United States
(12) Patent Application Publication
(10) Pub. No.: US 2023/0152732 A1
(43) Pub. Date: May 18, 2023

(54) IMAGE FORMING APPARATUS

(71) Applicant: Naoki Ohta, Kanagawa (JP)

(72) Inventor: Naoki Ohta, Kanagawa (JP)

(73) Assignee: Ricoh Company, Ltd., Tokyo (JP)

(21) Appl. No.: 17/936,922

(22) Filed: Sep. 30, 2022

(30) Foreign Application Priority Data
Nov. 17, 2021 (JP) 2021-186885

(51) Int. Cl. G03G 15/08; G03G 15/20; G03G 15/00

(52) U.S. Cl. CPC G03G 15/0889; G03G 15/0891; G03G 15/205; G03G 15/5008; G03G 2215/085

(57) ABSTRACT

An image forming apparatus includes an image bearer, a developing device, a fixing device, and circuitry. The developing device contains a developer and develops a latent image on the image bearer with the developer. The developing device includes a stirrer to stir the developer. The fixing device fixes a toner image onto a sheet. The circuitry performs start-up operations after receiving a print start command and before starting a printing operation. The start-up operations includes starting a warm-up operation of the fixing device and starting, during the warm-up operation, a stirring operation in which the stirrer stirs the developer.

### CROSS-REFERENCE TO RELATED APPLICATION

This patent application is based on and claims priority pursuant to 35 U.S.C. § 119(a) to Japanese Patent Application No. 2021-186885, filed on Nov. 17, 2021, in the Japan Patent Office, the entire disclosure of which is hereby incorporated by reference herein.

### BACKGROUND

### Technical Field

Embodiments of the present disclosure relate to an image forming apparatus such as a copier, a printer, a facsimile machine, or a multifunction peripheral having at least two of copying, printing, and facsimile functions.

### Related Art

One type of image forming apparatus such as a copier or a printer perform start-up operations such as a warm-up operation after receiving a print-start command and before starting printing. In addition, the image forming apparatus corrects image forming conditions in order to maintain a constant image density.

### SUMMARY

This specification describes an improved image forming apparatus that includes an image bearer, a developing device, a fixing device, and circuitry. The developing device contains a developer and develops a latent image on the image bearer with the developer. The developing device includes a stirrer to stir the developer. The fixing device fixes a toner image onto a sheet. The circuitry performs start-up operations after receiving a print start command and before starting a printing operation. The start-up operations includes starting a warm-up operation of the fixing device and starting, during the warm-up operation, a stirring operation in which the stirrer stirs the developer.

This specification further describes an improved image forming apparatus that includes an image bearer, a developing device, and circuitry. The developing device contains a developer and develops a latent image on the image bearer with the developer. The developing device includes a stirrer to stir the developer. The circuitry performs start-up operations after receiving a print start command and before starting a printing operation. The start-up operations includes starting a stirring operation in which the stirrer stirs the developer. The circuitry adjusts a timing to start the stirring operation based on a cumulative image area rate of images printed in a previous job.

This specification still further describes an improved image forming apparatus that includes an image bearer, a developing device, and circuitry. The developing device contains a developer and develops a latent image on the image bearer with the developer. The developing device includes a stirrer to stir the developer. The circuitry performs start-up operations after receiving a print start command and before starting a printing operation. The start-up operations includes starting a stirring operation in which the stirrer stirs the developer. The circuitry starts the printing operation in response to a change amount of a toner charge amount of the developer stirred being equal to or smaller than a predetermined value.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic view of a configuration of an image forming apparatus according to a first embodiment of the present disclosure;

FIG. 2 is a partially enlarged view of an image forming device and a block diagram that relates to the image forming device in the image forming apparatus of FIG. 1;

FIG. 3 is a timing chart illustrating start-up operations before starting a printing operation;

FIG. 4 is a graph illustrating a relation between a stirring time for which a stirrer stirs developer in a developing device and a toner charge amount of the developer;

FIG. 5A is a timing chart illustrating start-up operations before starting the printing operation in a comparative embodiment;

FIG. 5B is a graph illustrating a relation between a stirring time for which the stirrer stirs the developer in the developing device and the toner charge amount of the developer in the comparative embodiment;

FIG. 6 is a flowchart of start-up operations performed by the image forming apparatus according to a second embodiment of the present disclosure;

FIG. 7 is a graph illustrating a relation between a stirring time for which the stirrer stirs the developer in the developing device and the toner charge amount of the developer in cases of different cumulative image area rates;

FIG. 8 is a timing chart of start-up operations performed by the image forming apparatus according to a third embodiment of the present disclosure;

FIG. 9 is a graph illustrating a relation between the stirring time for which the stirrer stirs the developer in the developing device and the toner charge amount of the developer in cases of different rotation speeds of the stirrer; and

FIG. 10 is a timing chart of start-up operations performed by the image forming apparatus according to a fourth embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. Identical reference numerals are assigned to identical components or equivalents and a description of those components is simplified or omitted.

A first embodiment is described below.

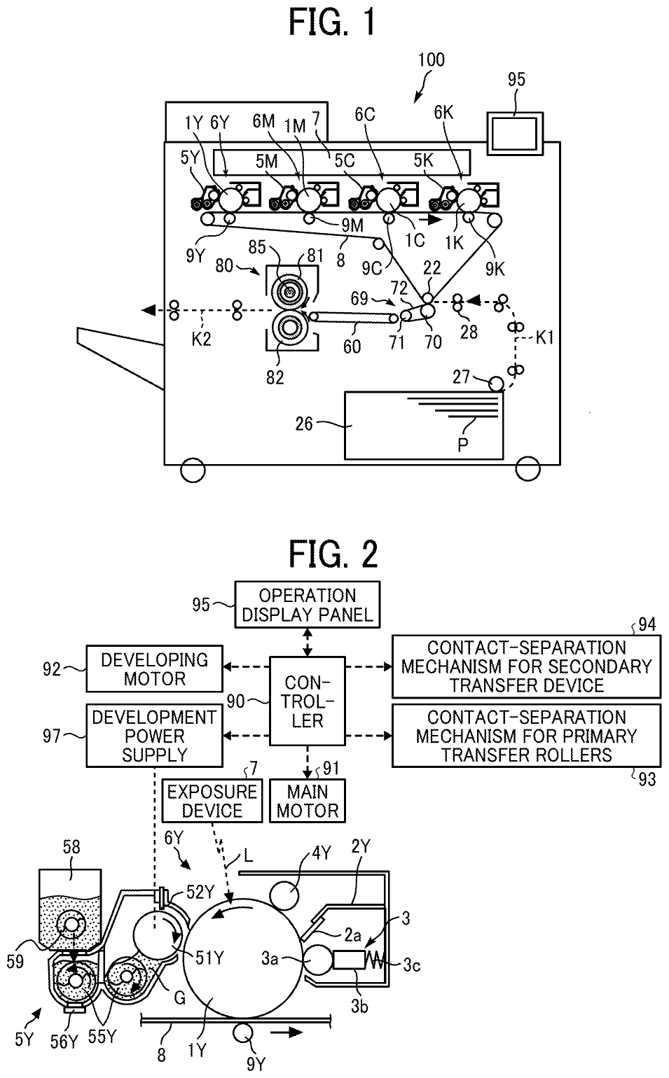

With reference to FIGS. 1 and 2, a description is given of the overall configuration and operations of an image forming apparatus 100.

FIG. 1 is a schematic view of a configuration of a printer as an example of the image forming apparatus. FIG. 2 is a partially enlarged view of an image forming device and a block diagram that relates to the image forming device in the image forming apparatus of FIG. 1.

As illustrated in FIG. 1, the image forming apparatus 100 includes an intermediate transfer belt 8 in the body of the image forming apparatus 100. The intermediate transfer belt 8 functions as an intermediate transferor. The image forming apparatus 100 further includes image forming devices 6Y, 6M, 6C and 6K, respectively corresponding to the colors of yellow, magenta, cyan, and black. The image forming devices 6Y, 6M, 6C and 6K are arranged in parallel, facing the intermediate transfer belt 8.

On the exterior of the body of the image forming apparatus 100, an operation display panel 95 is disposed. The operation display panel 95 displays information relating to printing operations (that is, image forming operations) and allows a user to perform operations relating to the printing operations.

Referring to FIG. 2, the image forming device 6Y that forms a yellow toner image includes a photoconductor drum 1Y, a charging device 4Y, a developing device 5Y, a cleaning device 2Y, a lubricant applicator 3, and a discharging device. The photoconductor drum 1Y functions as an image bearer. The charging device 4Y, the developing device 5Y, the cleaning device 2Y, the lubricant applicator 3, and the discharging device are disposed around the photoconductor drum 1Y. A series of image forming processes including charging, exposure, developing, primary transfer, cleaning, and electrical discharge processes is performed on the photoconductor drum 1Y. Accordingly, a yellow image is formed on the surface of the photoconductor drum 1Y.

The other three image forming devices 6M, 6C, and 6K also have almost the same configuration as the image forming device 6Y corresponding to yellow, except a configuration that the toner colors used are different. Due to such a configuration, a description below is given of the image forming device 6Y alone and descriptions of the other three image forming devices 6M, 6C, and 6K are appropriately omitted.

Referring to FIG. 2, the photoconductor drum 1Y as the image bearer is rotated counterclockwise by a main motor 91. The charging device 4Y uniformly charges the surface of the photoconductor drum 1Y in the charging process.

The photoconductor drum 1Y is rotated further until reaching a position opposite to and facing an exposure device 7. The exposure device 7 irradiates the surface of the photoconductor drum 1Y with a laser light beam L emitted from the exposure device 7 at this position and scans the surface of the photoconductor drum 1Y in a width direction, which is a main scanning direction orthogonal to the drawing sheets on which FIGS. 1 and 2 are drawn. By performing the above-described operation, the exposure device 7 forms or writes an electrostatic latent image corresponding to the color of yellow on the surface of the photoconductor drum 1Y in the exposure process.

After the electrostatic latent image is formed on the surface of the photoconductor drum 1Y, the photoconductor drum 1Y is rotated further and reaches a position facing the developing device 5Y. At the position, the developing device 5Y develops the electrostatic latent image into a visible toner image of yellow in the developing process.

Thereafter, the surface of the photoconductor drum 1Y reaches a position opposite a primary transfer roller 9Y and the intermediate transfer belt 8, and the toner image formed on the photoconductor drum 1Y is transferred to a surface of the intermediate transfer belt 8 at this position in the primary transfer process. After the primary transfer process, a certain amount of untransferred toner remains on the photoconductor drum 1Y.

When the surface of the photoconductor drum 1Y reaches a position facing the cleaning device 2Y, a cleaning blade 2a collects the untransferred toner from the photoconductor drum 1Y into the cleaning device 2Y in the cleaning process.

The cleaning device 2Y includes the lubricant applicator 3 for applying lubricant onto the photoconductor drum 1Y. The lubricant applicator 3 includes a lubricant supply roller 3a, a solid lubricant 3b, and a compression spring 3c. The lubricant supply roller 3a rotating clockwise in FIG. 2 scrapes a small amount of lubricant from the solid lubricant 3b and applies the lubricant to the surface of the photoconductor drum 1Y. Applying the lubricant to the surface of the photoconductor drum 1Y prevents the photoconductor drum 1Y and the cleaning blade 2a from wearing and deteriorating.

Finally, the surface of the photoconductor drum 1Y reaches a position facing the discharging device, and the discharging device removes residual potentials from the photoconductor drum 1Y.

Thus, a series of image forming processes performed on the surface of the photoconductor drum 1Y is completed.

The above-described image forming processes are performed in the image forming devices 6M, 6C, and 6K similarly to the image forming device 6Y for yellow. In other words, the exposure device 7 disposed above the image forming devices 6M, 6C, and 6K emits respective laser light beams L based on respective image data, toward a photoconductor drum 1M of the image forming device 6M, a photoconductor drum 1C of the image forming device 6C and a photoconductor drum 1K of the image forming device 6K. Specifically, the exposure device 7 includes a light source to emit the laser light beams L, multiple optical elements, and a polygon mirror that is rotated by a motor. The exposure device 7 scans, with the laser light beams L, the photoconductor drums 1M, 1C, and 1K via the multiple optical elements while deflecting the laser light beams L with the polygon mirror.

Subsequently, developing devices 5M, 5C, and 5K develop electrostatic latent images into visible magenta, cyan, and black toner images, respectively, in the development process. The magenta, cyan, and black toner images respectively formed on the photoconductor drums 1M, 1C, and 1K are primarily transferred onto the intermediate transfer belt 8 such that the magenta, cyan, and black toner images are superimposed one atop another. Thus, a color toner image is formed on the intermediate transfer belt 8.

The intermediate transfer belt 8 serving as an intermediate transferor is entrained around and supported by the multiple rollers and is formed into an endless loop. As a drive motor drives and rotates the drive roller, the intermediate transfer belt 8 is rotated in a direction indicated by arrow in FIG. 1.

Four primary transfer rollers 9Y, 9M, 9C, and 9K nip the intermediate transfer belt 8 together with the four photoconductor drums 1Y, 1M, 1C, and 1K to form the four primary transfer nips between the intermediate transfer belt 8 and the photoconductor drums 1Y, 1M, 1C, and 1K, respectively. A transfer voltage (i.e., a primary transfer bias) having a polarity opposite to a polarity of toner is applied to each of the primary transfer rollers 9Y, 9M, 9C, and 9K.

The intermediate transfer belt 8 travels in the direction indicated by arrow in FIG. 1 and sequentially passes through the primary transfer nips formed by the four primary transfer rollers 9Y, 9M, 9C, and 9K. Thus, the toner images formed on the respective photoconductor drums 1Y, 1M, 1C, and 1K are primarily transferred onto the intermediate transfer belt 8 in a manner of being superimposed one atop another to form a composite color toner image on the intermediate transfer belt 8 in the primary transfer process.

Subsequently, the intermediate transfer belt 8 bearing the composite color toner image reaches a position opposite a secondary transfer belt 72 (and a secondary transfer roller 70). At this position, a secondary transfer backup roller 22 sandwiches the intermediate transfer belt 8 and the secondary transfer belt 72 with the secondary transfer roller 70 to form an area of contact, herein called a secondary transfer nip (as a transfer nip), between the intermediate transfer belt 8 and the secondary transfer belt 72. At the secondary transfer nip, the composite color toner image (or four-color toner image including yellow, magenta, cyan, and black colors) is secondarily transferred from the intermediate transfer belt 8 onto a sheet P serving as a recording medium conveyed to the position of the secondary transfer nip, in a secondary transfer process. At this time, untransferred toner that is not transferred onto the sheet P remains on the surface of the intermediate transfer belt 8.

Thereafter, the intermediate transfer belt 8 reaches a position opposite the intermediate transfer belt cleaner. At this position, the intermediate transfer belt cleaner removes substances such as the untransferred toner adhering to the surface of the intermediate transfer belt 8.

Thus, a series of transfer processes performed on the surface of the intermediate transfer belt 8 is completed.

With reference to FIG. 1, the sheet P is conveyed from a sheet feeder 26 disposed in a lower portion of the body of the image forming apparatus 100 to the secondary transfer nip as the transfer nip via a feed roller 27 and a registration roller pair 28.

Specifically, the sheet feeder 26 contains a stack of multiple sheets P such as sheets of paper stacked on one on another. The feed roller 27 is rotated counterclockwise in FIG. 1 to pick up and feed an uppermost sheet P of the plurality of sheets P toward a portion between rollers of the registration roller pair 28 via a first sheet conveyance passage K1.

The sheet P conveyed to the registration roller pair 28 (that is a conveyance roller pair) temporarily stops at a position of the roller nip between the rollers of the registration roller pair 28 that has stopped rotating. Subsequently, the registration roller pair 28 rotates to convey the sheet P to the secondary transfer nip, timed to coincide with the arrival of the composite color toner image on the intermediate transfer belt 8. Thus, the desired color toner image is transferred onto the sheet P.

After the composite color toner image is secondarily transferred onto the sheet P at the secondary transfer nip, the secondary transfer belt 72 entrained around and supported by the secondary transfer roller 70 and a separation roller 71 conveys the sheet P. After the sheet P is separated from the secondary transfer belt 72, a conveyance belt 60 conveys the sheet P to a fixing device 80. In the fixing device 80, a fixing roller 81 and a pressure roller 82 apply heat and pressure to the sheet P to fix the composite color toner image on the sheet P, which is a fixing process.

The sheet P is conveyed through a second conveyance passage K2 and ejected by an ejection roller pair to the outside of the image forming apparatus 100. The sheets P ejected by the ejection roller pair to the outside of the image forming apparatus 100 are sequentially stacked as output images on a stack tray.

Thus, a series of image forming processes (i.e., printing operations) of the image forming apparatus 100 is completed.

The fixing device 80 includes the fixing roller 81 as a fixing rotator, a heater 85, the pressure roller 82 as a pressure rotator, and a temperature sensor to detect a temperature (a surface temperature) of the fixing roller 81. The heater 85 is secured inside the hollow core of the fixing roller 81.

When the image forming apparatus 100 is powered on, a power supply supplies power to the heater 85. A controller 90 as circuitry controls the power supplied to the heater 85, that is, an output of the heater 85. Radiant heat from the heater 85 heats the fixing roller 81, and the fixing roller 81 applies heat to the toner image on the sheet P entering a fixing nip between the fixing roller 81 and the pressure roller 82.

The controller 90 controls the output of the heater 85 based on the detection result of a surface temperature of the fixing roller 81 (specifically, a temperature of the outer circumferential surface of the fixing roller 81) detected by the temperature sensor. The temperature sensor is disposed opposite (facing) the outer circumferential surface of the fixing roller 81. The above-described control of the power supplied to the heater 85 adjusts the temperature of the fixing roller 81 (that is, a fixing temperature) to a desired temperature (that is, a target control temperature).

The image forming apparatus 100 in the first embodiment includes a contact-separation mechanism 93 for the primary transfer rollers (see FIG. 2) that vertically moves the primary transfer rollers 9Y, 9M, 9C, and 9K. During normal printing operations, the contact-separation mechanism 93 for the primary transfer rollers moves the primary transfer rollers 9Y, 9M, 9C, and 9K to positions illustrated in FIG. 1 so as to come into contact with the photoconductor drums 1Y, 1M, 1C, and 1K via the intermediate transfer belt 8, respectively. In contrast, when printing is not performed, the contact-separation mechanism 93 for the primary transfer rollers moves the primary transfer rollers 9Y, 9M, 9C, and 9K downward from the positions illustrated in FIG. 1 to release contacts between the photoconductor drums 1Y, 1M, 1C, and 1K and the intermediate transfer belt 8 in order to prevent elastic distortion of the intermediate transfer belt 8 and the primary transfer rollers 9Y, 9M, 9C, and 9K.

The image forming apparatus 100 in the first embodiment includes a contact-separation mechanism 94 (see FIG. 2) for a secondary transfer device 69 that vertically moves the secondary transfer device 69. During normal printing operations, the contact-separation mechanism 94 for the secondary transfer device 69 moves the secondary transfer device 69 to a position illustrated in FIG. 1 so as to come into contact with the secondary transfer backup roller 22 via the intermediate transfer belt 8. In contrast, when printing is not performed, the contact-separation mechanism 94 for the secondary transfer device 69 moves the secondary transfer device 69 downward from the position illustrated in FIG. 1 to release contacts between the secondary transfer device 69 and the intermediate transfer belt 8 in order to prevent elastic distortion of the intermediate transfer belt 8, the secondary transfer roller 70, a secondary transfer belt 72, and the secondary transfer backup roller 22.

Next, a detailed description is provided of a configuration and operation of the developing device 5Y of the image forming device 6Y with reference to FIG. 2.

The developing device 5Y includes a developing roller 51Y as a developer bearer disposed opposite the photoconductor drum 1Y, a doctor blade 52Y disposed opposite the developing roller 51Y, two conveying screws 55Y as stirrers disposed in developer containers, and a toner concentration sensor 56Y to detect concentration of toner in a developer. The developing roller 51Y includes a magnet and a sleeve. The magnet is fixed inside the developing roller 51Y. The sleeve rotates about the magnet. The developer containers contain the developer G that is a two-component developer including carrier (carrier particles) and toner (toner particles).

The developing device 5Y configured as described above operates as follows.

The sleeve of the developing roller 51Y rotates in the direction indicated by arrow illustrated in FIG. 2. The developer G held on the developing roller 51Y by the magnetic field generated by the magnet moves along the circumference of the developing roller 51Y (in the direction of arc) as the sleeve rotates. The percentage (concentration) of toner in the developer (ratio of toner to carrier) in the developing device 5Y is constantly adjusted within a predetermined range. Specifically, in response to detection of low toner concentration by the toner concentration sensor 56Y disposed in the developing device 5Y, driving a supply roller 59 disposed inside a toner container 58 to rotate supplies fresh toner (new toner) from the toner container 58 into the developing device 5Y so that the toner concentration falls within the given range.

The two conveying screws 55Y as the stirrers stir and mix the developer G with the toner supplied from the toner container 58 to the developer container while circulating the developer G in the two developer containers separated each other. In this case, the developer G moves in the direction perpendicular to the surface of the sheet on which FIG. 2 is drawn. The toner in developer G is charged by friction with carrier and electrostatically attracted to the carrier. Then, the toner is carried on the developing roller 51Y together with the carrier by a magnetic force generated on the developing roller 51Y.

The developer G borne on the developing roller 51Y is transported in the direction indicated by arrow in FIG. 2 to the doctor blade 52Y. At this position, the doctor blade 52Y adjusts the amount of the developer G on the developing roller 51Y to an appropriate amount. Thereafter, the developer G on the developing roller 51Y is conveyed to a position opposite the photoconductor drum 1Y (i.e., a developing area). In the developing area, the toner is attracted to the latent image formed on the photoconductor drum 1Y by an electric field generated in the developing area. Thereafter, the developer G remaining on the developing roller 51Y is conveyed to an upper portion of the developer container along with rotation of the sleeve of the developing roller 51Y, where the developer G is separated from the developing roller 51Y.

The electric field in the developing area is generated by a development bias applied to the developing roller 51Y by a development power supply 97 and a surface potential (in other words, a latent image potential) formed on the surface of the photoconductor drum 1Y in the charging process and the exposure process.

A developing motor 92 drives the developing roller 51Y as the developer bearer, the two conveying screws 55Y as the stirrers to rotate them in the directions indicated by arrows in FIG. 2. Specifically, a driving force of the developing motor 92 is transmitted to the developing roller 51Y and the two conveying screws 55Y via a gear train.

The toner container 58 is detachably (replaceably) attached on the developing device 5Y in the image forming apparatus 100. Specifically, when the fresh toner contained in the toner container 58 is consumed to be empty, the toner container 58 with no toner is removed from the developing device 5Y in the image forming apparatus 100 and is replaced with a new toner container 58 with fresh toner.

The configuration and operation of the image forming apparatus 100 according to the first embodiment are described in further detail below.

As described above with reference to FIGS. 1 and 2, the image forming apparatus 100 according to the first embodiment includes the developing device 5Y that develops the latent image formed on the surface of the photoconductor drum 1Y as the image bearer and the fixing device 80 that fixes a transferred and unfixed toner image onto the sheet P. The developing device 5Y includes the conveying screws 55Y as the stirrers that stir the developer G in the developing device 5Y.

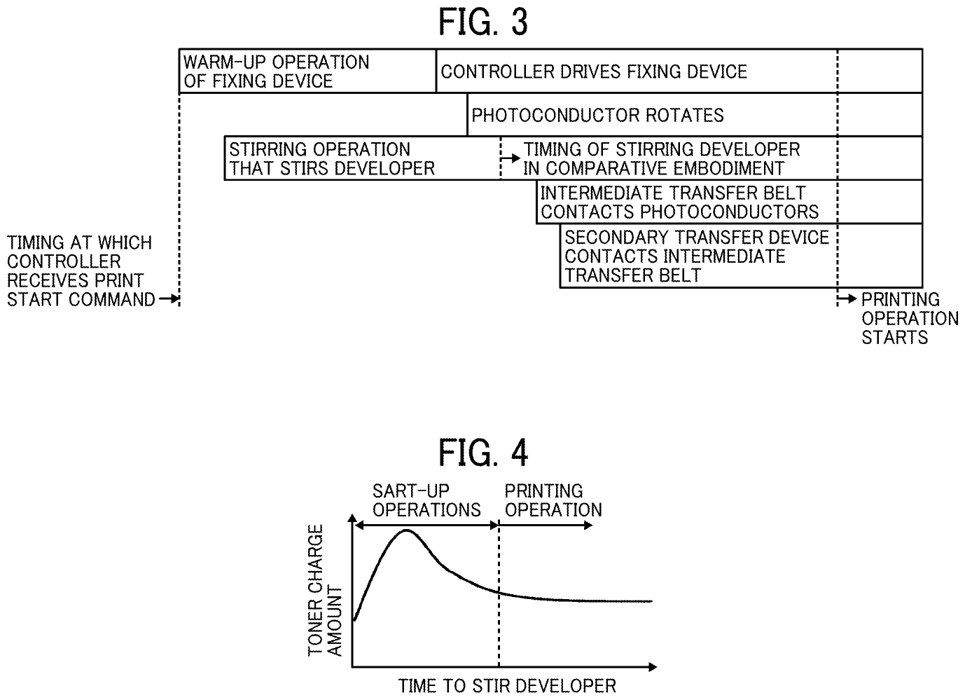

With reference to FIG. 3, the following describes start-up operations of the image forming apparatus 100 according to the first embodiment. The controller 90 performs the start-up operations after a timing at which the controller 90 receives a print start command and before starting the printing operation. After the controller 90 receives the print start command, the controller 90 starts a warm-up operation of the fixing device 80. During the warm-up operation, the controller 90 starts a stirring operation that stirs the developer G in the developing device 5Y. The stirring operation is performed by the two conveying screws 55Y as stirrers.

Specifically, an operator such as a user operates the operation display panel 95 to input various printing conditions such as the number of sheets to be printed and a printing mode (color mode, monochrome mode, or the like) and presses a print start button. Then, the controller receives the print start command and starts the start-up operations until printing is started. The start-up operations are preparation operations of main parts of the image forming apparatus 100 to perform a favorable printing operation.

Specifically, the controller 90 starts the warm-up operation of the fixing device 80, as the first start-up operation. In the warm-up operation, the controller 90 controls a power source to supply electric power to the heater 85 to raise the temperature of the fixing roller 81 to a desired temperature (that is, a fixing temperature). The longer the image forming apparatus 100 is left and the cooler the fixing roller 81, the longer the warm-up operation to raise the temperature of the fusing roller 81. Therefore, the controller 90 preferentially performs the warm-up operation before other preparation operations. In particular, the controller 90 in the first embodiment starts the warm-up operation of the fixing device 80 immediately after receiving the print start command as illustrated in FIG. 3.

After the electric power is supplied to the heater 85 to some extent, the controller 90 drives the fixing device 80. While the fixing roller 81 and the pressure roller 82 rotate, the controller 90 controls the electric power supplied from the power source to the heater 85 based on the result detected by the temperature sensor that detects the temperature of the fixing roller 81 to uniform temperatures of the fixing roller 81 in the circumferential direction of the fixing roller 81.

While the fixing device 80 is activated as described above, the main motor 91 starts to rotationally drive the photoconductor drums 1Y, 1M, 1C, and 1K. Subsequently, the contact-separation mechanism 93 of the primary transfer rollers moves the primary transfer rollers 9Y, 9M, 9C, and 9K and the intermediate transfer belt 8, which are separated from the photoconductor drums 1Y, 1M, 1C, and 1K, to bring the intermediate transfer belt 8 into contact with the photoconductor drums 1Y, 1M, 1C, and 1K as illustrated in FIGS. 1 and 2. Next, the contact-separation mechanism 94 for the secondary transfer device moves the secondary transfer device 69 that is separated from the intermediate transfer belt 8 to bring the secondary transfer device 69 into contact with the intermediate transfer belt 8 as illustrated in FIG. 1.

Then, the controller 90 completes the start-up operations and starts the printing operation set by the operator.

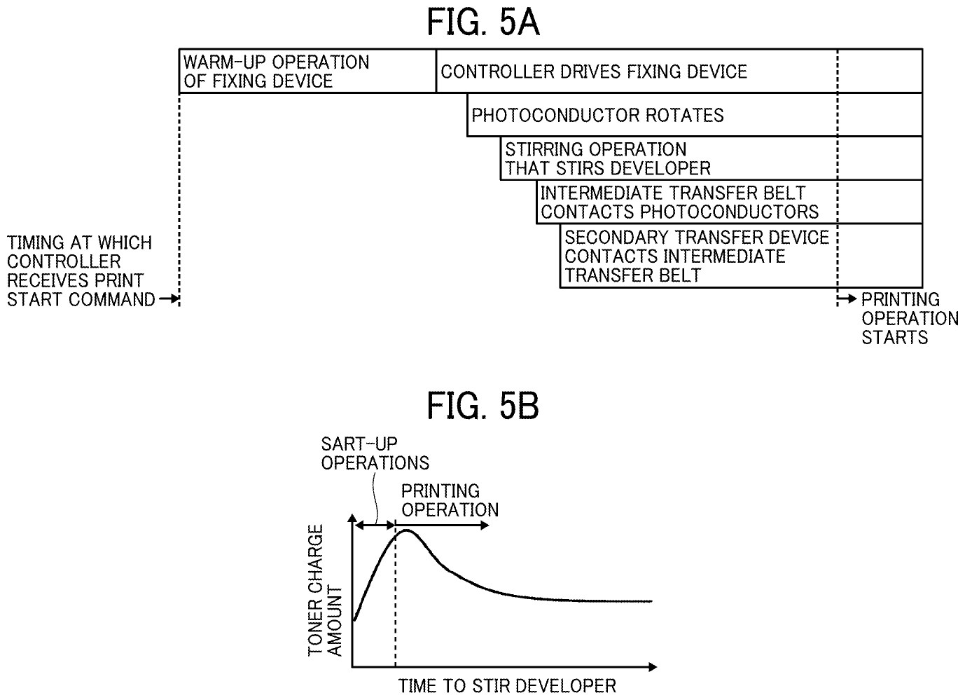

FIG. 5A is a timing chart of start-up operations according to a comparative embodiment. In FIG. 5A, the controller 90 activates the fixing device 80 and starts rotating the photoconductor drums 1Y, 1M, 1C, and 1K after the warm-up operation of the fixing device 80 is completed. Subsequently, the controller 90 starts rotating the conveying screws 55Y as the stirrers to start stirring the developer G in the developing device 5Y. In contrast, the controller 90 according to the first embodiment starts, during the warm-up operation of the fixing device 80, rotating the conveying screws 55Y as the stirrers to start stirring the developer G in the developing device 5Y. Specifically, the controller 90 starts the warm-up operation of the fixing device 80 in response to receiving the print start command and, after a few moments, starts driving the developing motor 92 to start driving the developing device 5Y (that is, rotating the conveying screws 55Y and the developing roller 51Y). In other words, the timing of start of stirring the developer G in the developing device 5Y according to the first embodiment illustrated in FIG. 3 is faster than the timing of start of stirring the developer G in the developing device 5Y according to the comparative embodiment illustrated in FIG. 5A. The timing of start of stirring the developer G in the first embodiment is accelerated from the timing of start of stirring the developer in the comparative embodiment. That is to say, a stirring time to stir the developer G during the start-up operations in the first embodiment is longer than that in the comparative embodiment.

In the first embodiment, the conveying screws 55Y as the stirrers start stirring the developer G in the developing device 5Y in the start-up operations and continue stirring the developer G after the start of printing operation.

In other words, the developing motor 92 starts driving in the start-up operations and continues the driving until the printing operation is completed after the start of the printing operation without being interrupted.

As described above, the start-up operations according to the first embodiment having a sufficient time to stir the developer G during the warm-up operation of the fixing device 80 stabilize a toner charge amount of the developer G contained in the developing device 5Y immediately after the start of printing. As a result, the image forming apparatus according to the first embodiment prevents a disadvantage that the image density varies in images printed immediately after the start of printing.

The following describes the above-described effect according to present the embodiment in detail.

In order to stabilize the image density in printed images, the states of the toner in the developer G, such as toner concentration, toner charge amount, and toner deterioration state, are controlled. Under a constant developing potential, which means a constant developing electrical field formed by the difference between the developing bias and the latent image potential, the toner charge amount is inversely proportional to the amount of toner developed on the photoconductor drum 1Y that represents an image density on the photoconductor drum 1Y. Accordingly, decreasing variations in the toner charge amount decreases variations in the image density.

Sufficiently stirring the developer G is important to decrease variations in the toner charge amount. In particular, after the developing device is stopped and left, the toner charge amount of the developer G rapidly increases immediately after the start of stirring, reaches a maximum, and then gradually decreases to converge to a stable state, as illustrated in FIG. 4. Start-up operations according to the comparative embodiment not having the sufficient time to stir the developer G results in starting the printing operation before the toner charge amount sufficiently decreases to converge to the stable state as illustrated in FIG. 5B, causing the image density in the image printed immediately after the start of printing operation to be lower than the image density in the image printed thereafter.

In contrast, the start-up operations according to the first embodiment having the sufficient time to stir the developer G results in starting the printing operation after the toner charge amount sufficiently decreases to converge to the stable state as illustrated in FIG. 4, causing the image density in the image printed immediately after the start of printing operation to be stable. Setting the time to stir the developer G in the start-up operations of the first embodiment to be longer than that of the comparative embodiment within the time for the warm-up operation of the fixing device 80 does not cause a disadvantage that a first print time (that is, a time until the image forming apparatus 100 starts the printing operation) becomes longer.

In the start-up operations according to the first embodiment, the developing motor 92 rotates the conveying screws 55Y as the stirrers and the developing roller 51Y to stir the developer G.

However, the developing roller 51Y may not be rotated in the start-up operations, and only the conveying screws 55Y as the stirrers may be rotated to stir the developer G. In this case, the image forming apparatus 100 includes another driver to drive and rotate the conveying screws 55Y as the stirrers in addition to the driver to drive and rotate the developing roller 51Y.

As described above, the image forming apparatus 100 according to the first embodiment includes the photoconductor drum 1Y as the image bearer, the developing device 5Y, and the fixing device 80. The developing device 5Y includes the conveying screws 55Y as the stirrers to stir the developer G inside the developing device 5Y and develops the latent image formed on the surface of the photoconductor drum 1Y into the toner image. The toner image is transferred to the sheet P. The fixing device 80 fixes the transferred and unfixed toner image onto the sheet P. In addition, the image forming apparatus 100 according to the first embodiment includes the controller 90 as the circuitry. The controller 90 performs the start-up operations after the controller 90 receives the print start command. The start-up operations includes the warm-up operation of the fixing device 80. During the warm-up operation, the controller 90 starts the stirring operation that stirs the developer G in the developing device 5Y, which is performed by the conveying screws 55Y as stirrers.

The above-described configuration and operations can stabilize the image density in the images printed immediately after the start of printing.

A second embodiment is described below.

Similar to the image forming apparatus 100 according to the first embodiment, the image forming apparatus 100 according to the second embodiment includes the developing device 5Y including the conveying screws 55Y as the stirrers.

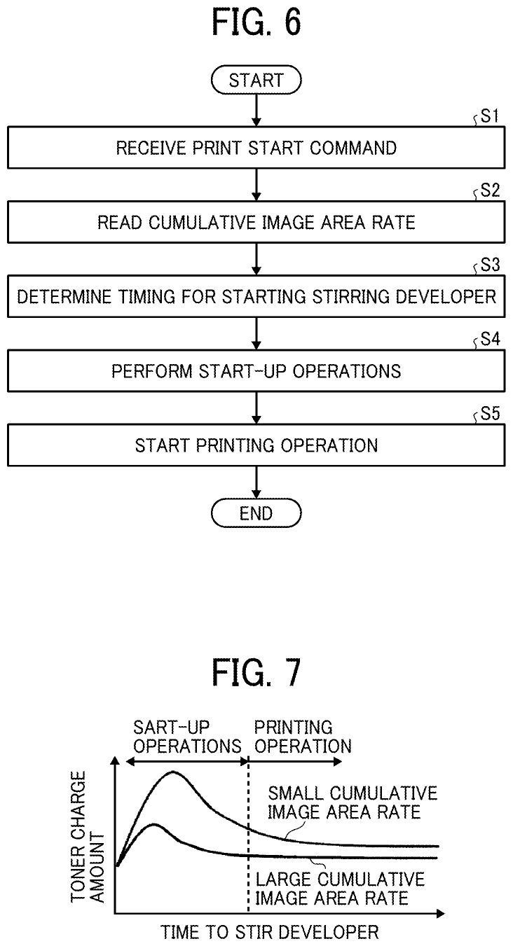

With reference to FIG. 6, the following describes start-up operations of the image forming apparatus 100 according to the second embodiment. The controller 90 performs the start-up operations after the controller 90 receives the print start command and before starting the printing operation. The controller 90 stores a cumulative image area rate that is a sum of image area rates of all images sequentially printed before receiving the print start command, that is, the cumulative image area rate in a previous print job. Based on the cumulative image area rate, the controller 90 adjusts a timing to start the stirring operation that stirs the developer G in the developing device 5Y, which is performed by the two conveying screws 55Y as stirrers during the start-up operations.

Specifically, based on a small cumulative image area rate in the previous job, the controller 90 sets the timing to start stirring the developer G during the start-up operations to be earlier than the timing set based on a large cumulative image area rate.

As illustrated in FIG. 6, the controller receives the print start command in step 51, reads the cumulative image area rate in the previous job in step S2, and determines the timing for starting the rotation of the conveying screws 55Y, that is, the timing for starting to stir developer, during the start-up operations based on the cumulative image area rate in step S3. In step S4, the controller 90 performs the start-up operations including the operation that starts at the determined timing. After completing the start-up operations, the controller 90 starts the printing operation in step S5.

The reason why the above-described control is performed is as follows. As illustrated in FIG. 7, an increase in the toner charge amount after the stirrers start stirring the developer G in a case of the small cumulative image area rate in the previous print job is larger than that in a case of the large cumulative image area rate. The larger the increase in the toner charge amount, the longer the time until the toner charge amount stabilizes. For this reason, based on the small cumulative image area rate in the previous job, the controller 90 according to the second embodiment sets the timing to start stirring the developer G to be earlier than the timing set based on the large cumulative image area rate so as to take a long time for stirring the developer G during the start-up operations. As a result, the toner charge amount after the start of the printing operation is stabilized regardless of the cumulative image area rate in the previous print job.

The image area rate is obtained by dividing an image area by an area in which the image can be formed and proportional to the amount of toner consumed in the developing device 5Y and the number of pixels of latent images written by the exposure device 7. In the second embodiment, the controller 90 acquires the number of pixels from the exposure device 7, calculates the cumulative image area rate, stores the cumulative image area rate in a memory in the controller 90, and adjusts the timing to start stirring the developer G based on the cumulative image area rate.

As described above, the image forming apparatus 100 according to the second embodiment includes the photoconductor drum 1Y as the image bearer and the developing device 5Y. The developing device 5Y includes the conveying screws 55Y as the stirrers to stir the developer G inside the developing device 5Y and develops the latent image formed on the surface of the photoconductor drum 1Y into the toner image. The controller 90 performs the start-up operations after the controller 90 receives the print start command and before starting printing. The controller 90 stores the cumulative image area rate that is the sum of image area rates of all images sequentially printed before receiving the print start command, that is, the cumulative image area rate in the previous print job. Based on the cumulative image area rate, the controller 90 adjusts the timing to start the stirring operation that stirs the developer G in the developing device 5Y, which is performed by the two conveying screws 55Y as stirrers during the start-up operations.

The above-described configuration and operations can stabilize the image density in the images printed immediately after the start of printing.

A third embodiment is described below.

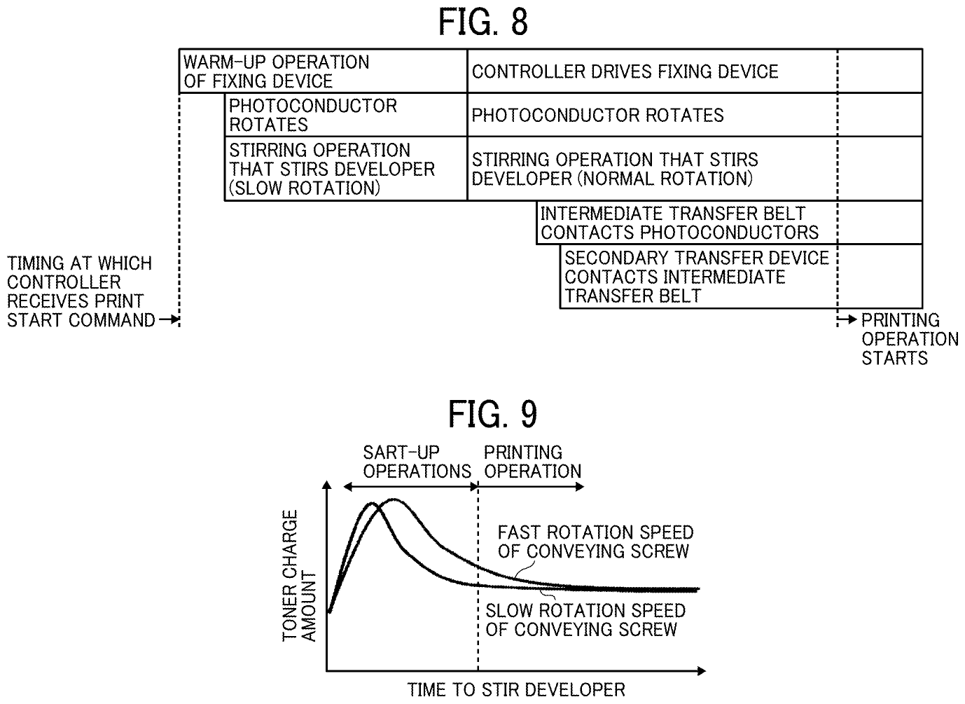

As illustrated in FIG. 8, the image forming apparatus 100 according to the third embodiment is different from the image forming apparatus 100 according to the first embodiment in that the start-up operations include a time for which the rotation speed of the conveying screw 55Y as the stirrer is slower than the rotation speed of the conveying screw 55Y during the printing operation.

Specifically, the developing motor 92 is a variable rotation speed motor, and the controller 90 controls the developing motor 92 so that the rotation speed of the conveying screw 55Y during the time in the start-up operations is slower than the rotation speed of the conveying screw 55Y during the printing operation.

The reason why the above-described control is performed is as follows. As illustrated in FIG. 9, the slower the rotation speed of the conveying screw 55Y, the shorter the time for which the toner charge amount increases to a maximum value after the start of stirring the developer G, which shortens a time to stabilize the toner charge amount. For this reason, the controller 90 in the third embodiment sets the rotation speed of the conveying screw 55Y for the time during the start-up operations to be smaller than the rotation speed of the conveying screw 55Y during the printing operation to stabilize the toner charge amount at an early stage. As a result, the time taken for the start-up operations is reduced.

Thus, similar to the above-described embodiments, above-described configuration and operations in the image forming apparatus 100 according to the third embodiment can stabilize the image density in the images printed immediately after the start of printing.

In addition, as illustrated in FIG. 8, the controller 90 in the third embodiment controls the main motor 91 to drive and rotate the photoconductor drum 1Y as the image bearer together with the developing roller 51Y as the developer bearer and controls the development power supply 97 to apply the developing bias to the developing roller 51Y when the conveying screws 55Y as the stirrers are driven to rotate during the start-up operations.

In other words, in the start-up operations, the controller 90 controls the developing motor 92 to start driving the conveying screws 55Y to start stirring the developer. At the same time, the controller 90 controls the development power supply 97 to supply the developing bias to the developing roller 51Y that is driven to rotate and controls the main motor 91 to start rotating the photoconductor drum 1Y.

Performing the above-described control consumes toner of the developer G in the developing device 5Y (the toner is adhered to the photoconductor drum 1Y). As a result, the above-described control can reduce the deterioration of the toner of the developer G compared with the control that does not consume the toner of the developer G even when the developer G is stirred for a long time during the start-up operations. The deterioration of the toner causes a vertical streak image (mainly caused by lubricant unevenly applied to the photoconductor drum 1Y). The above-described control can prevent such a disadvantage.

A fourth embodiment is described below.

Similar to the image forming apparatus 100 according to the above-described embodiments, the image forming apparatus 100 according to the fourth embodiment includes the developing device 5Y including the conveying screws 55Y as the stirrers.

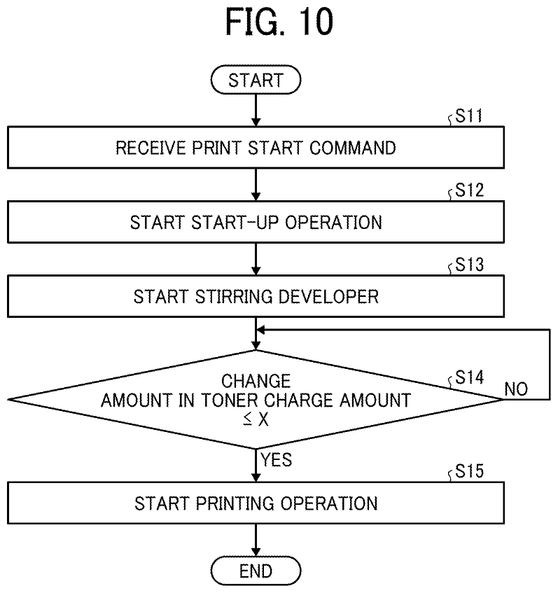

With reference to FIG. 10, the following describes start-up operations of the image forming apparatus 100 according to the fourth embodiment. The controller 90 performs the start-up operations after the controller 90 receives the print start command and before starting printing. In the start-up operations, the controller 90 starts the stirring operation that stirs the developer G in the developing device 5Y, which is performed by the conveying screws 55Y as stirrers. Subsequently, the controller 90 starts the printing operation after a change amount in the toner charge amount of the toner of the developer G is equal to or smaller than a predetermined value X.

As illustrated in FIG. 10, after the controller 90 receives the print start command in step S11, the controller 90 starts the start-up operations in step S12 and starts rotating the conveying screws 55Y to start stirring the developer during the start-up operations in step S13. Subsequently, the controller 90 determines whether the change in the toner charge amount of the toner of the developer G is equal to or smaller than the predetermined value X in step S14. When the change amount in the toner charge amount of the toner of the developer G is equal to or smaller than the predetermined value X, the toner charge amount is stable, and the image density is stable. Therefore, the controller 90 completes the start-up operations and starts the printing operation in step S15.

The toner charge amount of the toner of the developer G in the developing device 5Y may be directly detected by an electrostatic sensor or the like disposed in the developing device 5Y or may be indirectly detected by developing a toner image for a toner charge detection on the photoconductor drum 1Y and detecting the image density of the toner image.

Thus, the above-described configuration and operations in the image forming apparatus 100 according to the fourth embodiment can stabilize the image density in the images printed immediately after the start of printing.

In the above-described embodiments, the image forming apparatus 100 includes the intermediate transfer belt 8 as an intermediate transferor, the secondary transfer roller 70, and the secondary transfer belt 72, as a transfer device, but the present disclosure is not limited to this. Alternatively, the present disclosure may be applied to an image forming apparatus using a direct transfer system. The direct transfer system does not include an intermediate transferor such as an intermediate transfer belt or an intermediate transfer drum. The image forming apparatus using the direct transfer system includes the developing device, a photoconductor such as the photoconductor drum on which the developing device develops the toner image, and a transfer device such as a transfer roller or a transfer belt to transfer the toner image on the photoconductor drum onto the sheet conveyed to a position of the photoconductor drum.

In the above-described embodiments, the image forming apparatus 100 includes the secondary transfer roller 70 and the secondary transfer belt 72 as the transfer device, but the present disclosure is not limited to this. The present disclosure may be applied to the image forming apparatus not including the transfer belt but including the secondary transfer roller as the transfer device.

In the above-described embodiments, the present disclosure is applied to the image forming apparatus 100 that forms color image. Alternatively, the present disclosure may also be applied to an image forming apparatus that forms a monochrome image alone.

In the above-described embodiments, a developing device such as the developing device 5Y includes a two component developer including toner and carrier, but the developing device may include a one component developer including only toner. In the developing device including the one component developer, a developing roller as the developer bearer may be in contact with the photoconductor drum as the image bearer.

In the above-described embodiments, the developing device 5Y includes two conveying screws 55Y as the stirrers horizontally arranged in parallel and the doctor blade 52Y disposed above the developing roller 51Y. However, the configuration of the developing device is not limited to the above-described configurations. The present disclosure may be applied to other developing devices such as a developing device including one stirrer or three or more stirrers, a developing device including multiple stirrers vertically arranged, or a developing device including the doctor blade disposed below the developing roller.

In the above-described embodiments, the heater 85 is used as the heater in the fixing device 80, but the heater in the fixing device is not limited to this. The heater may be an electromagnetic induction coil or a resistive heat generator.

Two or more of the configurations and controls in the above embodiments may be combined as appropriate.

In such configurations, effects similar to those described above are attained.

The above-described embodiments are illustrative and do not limit this disclosure. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape are not limited the embodiments and thus may be preferably set.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. An image forming apparatus comprising:
an image bearer;
a developing device configured to contain a developer and develop a latent image on the image bearer with the developer, the developing device including a stirrer configured to stir the developer;
a fixing device configured to fix a toner image onto a sheet; and
circuitry configured to perform start-up operations after receiving a print start command and before starting a printing operation, the start-up operations including:
starting a warm-up operation of the fixing device; and
starting, during the warm-up operation, a stirring operation in which the stirrer stirs the developer.

2. The image forming apparatus according to claim 1,
wherein the circuitry is configured to start the warm-up operation immediately after receiving the print start command.

3. The image forming apparatus according to claim 1,
wherein the circuitry is configured to set a rotation speed of the stirrer at least temporarily during the start-up operations to be slower than a rotation speed of the stirrer during the printing operation.

4. The image forming apparatus according to claim 1,
wherein the developing device includes a developer bearer, and
wherein the circuitry is configured to rotate the developer bearer and the image bearer together with the stirrer and apply a developing bias to the developer bearer during the stirring operation.

5. The image forming apparatus according to claim 1,
wherein the circuitry is configured to continue to perform the stirring operation after starting the printing operation.

6. The image forming apparatus according to claim 1,
wherein the circuitry is configured to adjust a timing to start the stirring operation based on a cumulative image area rate of all images printed in a previous job.

7. The image forming apparatus according to claim 1,
wherein the circuitry is configured to start the printing operation in response to a change amount of a toner charge amount of the developer stirred being equal to or smaller than a predetermined value.

8. An image forming apparatus comprising:
an image bearer;
a developing device configured to contain a developer and develop a latent image on the image bearer with the developer, the developing device including a stirrer configured to stir the developer; and
circuitry configured to perform start-up operations after receiving a print start command and before starting a printing operation, the start-up operations including starting a stirring operation in which the stirrer stirs the developer, the circuitry configured to change a timing to start the stirring operation at least partially based on a cumulative image area rate of images printed in a previous job.

9. The image forming apparatus according to claim 8,
wherein the circuitry is configured to adjust the timing to start the stirring operation based on the cumulative image area rate earlier than a timing to start the stirring operation based on a cumulative image area rate larger than the cumulative image area rate.

10. The image forming apparatus according to claim 8,
wherein the circuitry is configured to set a rotation speed of the stirrer at least temporarily during the start-up operations to be slower than a rotation speed of the stirrer during the printing operation.

11. The image forming apparatus according to claim 8,
wherein the developing device includes a developer bearer, and
wherein the circuitry is configured to rotate the developer bearer and the image bearer together with the stirrer and apply a developing bias to the developer bearer during the stirring operation.

12. The image forming apparatus according to claim 8,
wherein the circuitry is configured to continue to perform the stirring operation after starting the printing operation.

13. An image forming apparatus comprising
an image bearer;
a developing device configured to contain a developer and develop a latent image on the image bearer with the developer, the developing device including a stirrer configured to stir the developer; and
circuitry configured to perform start-up operations after receiving a print start command and before starting a printing operation, the start-up operations including starting a stirring operation in which the stirrer stirs the developer, the circuitry configured to start the printing operation in response to a change amount of a toner charge amount of the developer stirred being equal to or smaller than a predetermined value.

14. The image forming apparatus according to claim 13,
wherein the circuitry is configured to set a rotation speed of the stirrer at least temporarily during the start-up operations to be slower than a rotation speed of the stirrer during the printing operation.

15. The image forming apparatus according to claim 13,
wherein the developing device includes a developer bearer, and
wherein the circuitry is configured to rotate the developer bearer and the image bearer together with the stirrer and apply a developing bias to the developer bearer during the stirring operation.

16. The image forming apparatus according to claim 13,
wherein the circuitry is configured to continue to perform the stirring operation after starting the printing operation.
